(19) United States
(12) Patent Application Publication
(10) Pub. No.: US 2007/0182565 A1
(43) Pub. Date: Aug. 9, 2007

(54) Radio frequency identification tag and method of driving the same

(75) Inventors: Dong-hyun Lee, Seongnam-si (KR); Ja-nam Ku, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/528,617

(22) Filed: Sep. 28, 2006

(30) Foreign Application Priority Data
Feb. 8, 2006 (KR) 2006-12163

(51) Int. Cl. G08B 13/14

(52) U.S. Cl. 340/572.8

(57) ABSTRACT

A radio frequency identification (RFID) tag capable of improving convenience of a user and a method of driving the RFID tag are provided. The RFID tag includes a displaying unit displaying tag data indicating a current state of the RFID tag. The displaying unit displays the tag data even when the RFID tag does not exist in a read range of the RFID reader. Thus, a user can recognize the current state of the RFID tag without using the RFID reader.

### CROSS-REFERENCE TO RELATED APPLICATIONS

This application claims priority under 35 U.S.C. §119 from Korean Patent Application No. 10-2006-12163 filed on Feb. 8, 2006, in the Korean Intellectual Property Office, the disclosure of which is incorporated herein by reference in its entirety.

### BACKGROUND OF THE INVENTION

1. Field of the Invention

Apparatuses and methods consistent with the present invention relate to a radio frequency identification (RFID) tag and a method of driving the same, and more particularly, to an RFID tag capable of improving service convenience and a method of driving the same.

2. Description of the Related Art

Radio frequency identification (RFID) is automatic identification technology using a radio frequency (RF), which can substitute for barcodes and magnetic cards and is representative of contactless integrated circuit (IC) cards.

Such an RFID system includes an RFID reader, a host computer, and a transponder, i.e., an RFID tag.

The RFID reader transmits an electric wave to the RFID tag, and the RFID tag receives the electric wave and transmits data corresponding to the electric wave to the RFID reader.

The RFID tag includes an antenna through which the electric wave is transmitted to and/or received from the RFID reader and a drive chip which stores data such as identification (ID) information for identifying individual RFID tags. When the RFID tag receives the electric wave from the RFID reader, the RFID tag transmits data including ID information corresponding to the electric wave.

The RFID tag is classified into active and positive RFID tags by an operation method. The active RFID tag includes a power source supplying a power for driving the RFID tag. The positive RFID tag does not include a power source supplying a power for driving the RFID tag but receives a power for driving the RFID tag along with the electric wave from the RFID reader.

The RFID reader authorizes the RFID tag using the ID information received from the RFID tag and provides predetermined data to the authorized RFID tag. Here, a display device connected to the RFID reader displays a result of transmitting and/or receiving data between the RFID reader and the RFID tag. For example, if the RFID tag is applied to a transportation card used to settle a transportation fare, a display device of a transportation card reader displays an amount deducted and the balance. Here, information as to the balance of the transportation card is stored in a drive chip of the transportation card.

As described above, the RFID tag does not include a display device displaying stored data. Thus, the stored data may be ascertained only through the RFID reader. As a result, a user may not ascertain the data stored in the RFID tag until transmission and/or reception of data between the RFID reader and the RFID tag is performed. Therefore, the user must usually memorize the data stored in the RFID tag.

Also, an error may occur in the transmission and/or reception of the data between the RFID reader and the RFID tag. If the user does not memorize the data stored in the RFID tag, the user may not ascertain the error.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. An aspect of the present general inventive concept is to provide a radio frequency identification (RFID) tag for displaying stored data to improve convenience of a user and a method of driving the RFID tag.

According to an aspect of the present invention, there is provided a radio frequency identification (RFID) tag including: a tag antenna receiving an input power and input data from an RFID reader and transmitting ID (identification) information corresponding to the input power to the RFID reader; a tag driving unit providing the ID information to the tag antenna and updating and storing tag data indicating a current state of the RFID tag using the input data; and a displaying unit driven using the input power received through the tag driving unit and displaying an image corresponding to the tag data.

The displaying unit may keep a current image displayed even when a power is cut off, and the displaying unit may consume a power when new tag data is received to display a new image.

The displaying unit may be formed of an electronic paper.

The RFID tag may further include a display driving unit receiving the input power and the tag data from the tag driving-unit to generate an image signal and providing the image signal to the displaying unit.

The tag driving unit may include: a memory storing the ID information and the tag data; and a controller detecting the ID information from the memory, providing the ID information to the tag antenna, updates the tag data using the input data, and providing the input power and the tag data to the displaying unit.

According to another aspect of the prevent invention, there is provided a method of driving an RFID tag, including: receiving an input power from an RFID reader; detecting ID information corresponding to the input power and transmitting the ID information to the RFID reader; and receiving input data from the RFID reader to update and display tag data.

The receiving of the input data from the RFID reader to update and display the tag data may include: determining whether the input data has been received; if it is determined that the input data has not been received, keeping a current image displayed; if it is determined that the input data has been received, updating the tag data using the input data; and displaying the updated tag data.

In an RFID tag and a method of driving the RFID tag according to the present invention, although the RFID tag does not exist within a read range of an RFID reader, the RFID tag can display tag data indicating a current state. Thus, a user can recognize the current state of the RFID tag without using the RFID reader. As a result, the RFID tag can improve convenience of the user.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a block diagram of a radio frequency identification (RFID) system according to an exemplary embodiment of the present invention;

FIG. 2 is a block diagram of a tag driving unit shown in FIG. 1;

FIG. 3 is a cross-sectional view of a displaying unit shown in FIG. 1 according to an exemplary embodiment of the present invention;

FIG. 4 is a flowchart of a process of generating input data in an RFID reader shown in FIG. 1;

FIG. 5 is a flowchart of a process of driving an RFID tag shown in FIG. 1; and

FIG. 6 is a flowchart of a process of displaying tag data illustrated in FIG. 5.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

FIG. 1 is a block diagram of a radio frequency identification (RFID) system according to an exemplary embodiment of the present invention. Referring to FIG. 1, the RFID tag system includes an RFID reader 100 and an RFID tag 200.

In detail, the RFID reader 100 includes an antenna 110 transmitting an electric wave and transmits data to and/or receives data from the RFID tag 200 using a radio frequency (RF). Here, the electric wave output from the RFID reader 100 includes an input power for driving the RFID tag 200. The RFID reader 100 receives identification (ID) information, e.g., an ID allocated to each RFID tag, from the RFID tag 200 and authorizes the RFID tag 200 using the ID. If the RFID reader 100 successfully authorizes the RFID tag 200, the RFID reader 100 transmits predetermined input data to the RFID tag 200.

The RFID tag 200 includes a tag antenna 210, a tag driving unit 220, a display driving unit 230, and a displaying unit 240.

The tag antenna 210 transmits data to and/or receives data from the RFID reader 100. In other words, the tag antenna 210 receives the input power and the input data from the RFID reader 100 and provides the input power and the input data to the tag driving unit 220. The tag antenna 210 also receives the ID and tag data from the tag driving unit 220 and transmits the ID and the tag data to the RFID reader 100.

Here, the tag data is data stored in the tag driving unit 220 and indicates brief information as to the RFID tag 200. The tag data is updated using the input data received from the RFID reader 100, and the contents of the tag data may vary with a use purpose of the RFID tag 200. For example, if the RFID tag 200 is used to settle a specific fare, the tag data may include the current balance, brief advertisement information as to related fields, and the like.

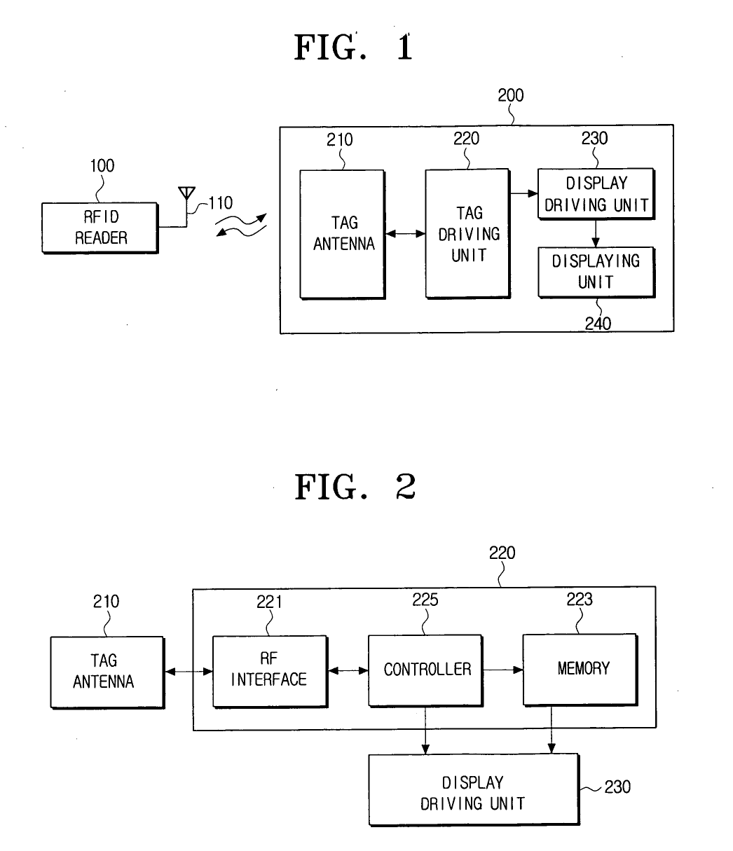

FIG. 2 is a block diagram of the tag driving unit 220 shown in FIG. 1. Referring to FIG. 2, the tag driving unit 220 is driven using the input power received from the tag antenna 210.

In detail, the tag driving unit 220 includes an RF interface 221, a memory 223, and a controller 225. In the present exemplary embodiment, the tag driving unit 220 may include at least one or more elements.

The RF interface 221 receives the input power from the tag antenna 210, converts the input power from an alternating current (AC) power into a direct current (DC) power, and provides the DC power to the controller 225. The RF interface 221 receives the input data from the tag antenna 210, converts the input data from an analog signal into a digital signal, and provides the digital signal to the controller 225. The RF interface 221 converts the digital signal received from the controller 225, i.e., the ID and the tag data into an analog signal, and provides the analog signal to the tag antenna 210.

The memory 223 stores the ID and the tag data under control of the controller 225. The memory 223 also provides the tag data to the display driving unit 230 under the control of the controller 225.

The controller 225 receives the input power from the RF interface 221 to control the RF interface 221 and the memory 223 and provides the input power to the display driving unit 230. The controller 225 detects the ID from the memory 223 in response to the input power and provides the ID to the RF interface 221. If the controller 225 receives a command to request the tag data from the RFID reader 100, the controller 225 detects the tag data from the memory 223 and provides the tag data to the RF interface 221. The controller 225 receives the input data from the RF interface 221 to update the tag data and stores the updated tag data in the memory 223. The controller 225 controls the memory 223 to provide the tag data to the display driving unit 230.

Referring to FIG. 1, the display driving unit 230 receives the input power from the tag driving unit 220 to be driven. The display driving unit 230 receives the tag data from the tag driving unit 220 to generate an image signal and provides the image signal to the displaying unit 240.

The displaying unit 240 receives the image signal from the display driving unit 230 to display an image, i.e., the tag data. In the present exemplary embodiment, the displaying unit 240 may be formed of an electronic paper driven at a low power. The electronic paper is thin, easily transformed, and easily carried. In particular, although a power is cut off, the electronic paper keeps a current image displayed. The electronic paper only consumes power when it displays a new image Thus, the displaying unit 240 may display the tag data using a low power.

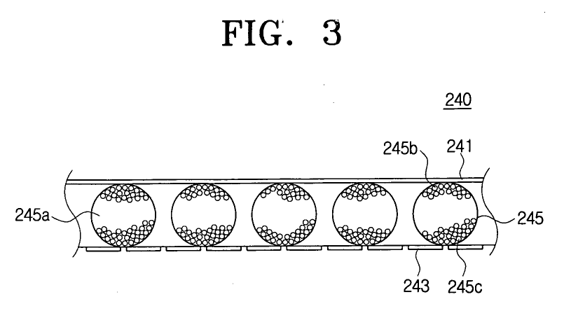

FIG. 3 is a cross-sectional view of the displaying unit 240 shown in FIG. 1 according to an exemplary embodiment of the present invention.

Referring to FIGS. 1 and 3, the displaying unit 240 includes an upper electrode 241, a lower electrode 243, and a plurality of micro capsules 245 interposed between the upper and lower electrodes 241 and 243. Here, the lower electrode 243 operates as a transistor and includes a plurality of pixels which are a basic unit for displaying an image.

The plurality of micro capsules 245 are mixed with a binder and then interposed between the upper and lower electrodes 241 and 243. The plurality of micro capsules 245 includes clear fluids 245a, a plurality of negatively electrified ink particles 245b, and a plurality of positively electrified ink particles 245c. The plurality of negatively electrified ink particles 245b and the plurality of positively electrified ink particles 245c are dispersed in the clear fluids 245a.

The plurality of pixels of the displaying unit 240 are driven in response to the image signal provided from the display driving unit 230. In other words, if a positive voltage is applied to a specific pixel, negatively electrified ink particles corresponding to the specific pixel move toward the upper electrode 241, and positively electrified ink particles corresponding to the specific pixel move toward the lower electrode 243. Thus, an image is displayed in the specific pixel.

If a negative voltage is applied to the specific pixel, negatively electrified ink particles corresponding to the specific pixel move toward the lower electrode 243, and positively electrified ink particles corresponding to the specific pixel move toward the upper electrode 241. Thus, the image is not displayed in the specific pixel.

As described above, the displaying unit 240 displays the tag data so that a user recognizes a current state of the RFID tag 200. Thus, the user can ascertain the tag data stored in the RFID tag 200 even when the RFID tag 200 does not exist within a read range of the RFID reader 100. As a result, the RFID tag 200 can improve convenience of the user.

In particular, the RFID tag 200 does not update the tag data until the RFID tag 200 receives the input data from the RFID reader 100. Thus, a current image is kept displayed on the displaying unit 240 until the input data is received from the RFID reader 100. As a result, the displaying unit 240 does not consume power until the tag data is updated. Therefore, the RFID tag 200 can display the tag data using low power.

A process of transmitting and/or receiving data between the RFID reader 100 and the RFID tag 200 will now be described with reference to the attached drawings.

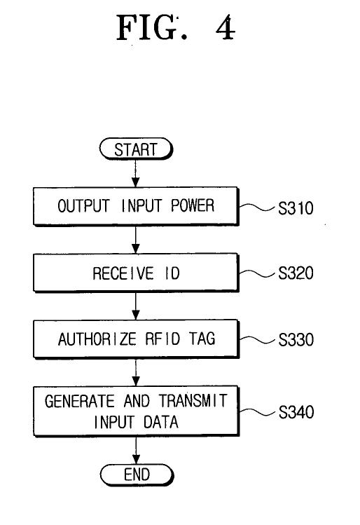

FIG. 4 is a flowchart of a process of generating the input data in the RFID reader 100 shown in FIG. 1. Referring to FIGS. 1 and 4, in operation S310, the RFID reader 100 outputs the input power through the antenna 110.

In operation S320, the RFID reader 100 receives the ID from the RFID tag 200 within the read range of the RFID reader 100, i.e., a magnetic field or an electrical field.

In operation S330, the RFID reader 100 authorizes the RFID tag 200 using the ID.

If the RFID reader 100 successfully authorizes the RFID tag 200, the RFID reader 100 generates the input data and transmits the input data to the RFID tag 200 through the antenna 110 in operation S340. Here, the RFID reader 100 may receive the tag data from the RFID tag 200 to receive the input data.

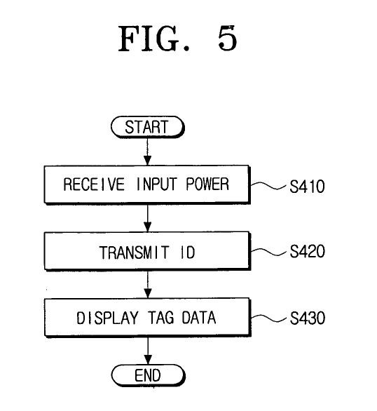

FIG. 5 is a flowchart of a process of driving the RFID tag 200 shown in FIG. 1. Referring to FIGS. 1 and 5, if the RFID tag 200 is positioned within the read range of the RFID reader 100, the tag antenna 210 receives the input power from the RFID reader 100 and provides the input power to the tag driving unit 220 in operation S410.

The tag driving unit 220 detects the ID in response to the input power and provides the ID to the tag antenna 210. In operation S420, the tag antenna 210 transmits the ID to the RFID reader 100.

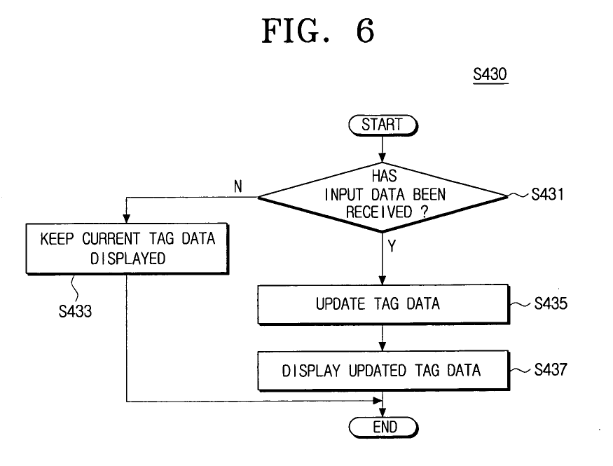

The tag antenna 210 receives the input data from the RFID reader 100 and provides the input data to the tag driving unit 220. In operation S430, the tag driving unit 220 updates the tag data using the input data, and the displaying unit 240 displays the image corresponding to the tag data. Here, the process of displaying the tag data will be described in detail with reference to FIG. 6.

FIG. 6 is a flowchart of the process of displaying the tag data illustrated in FIG. 5. Referring to FIGS. 1 and 6, in operation S431, the tag driving unit 220 determines whether the input data has been received.

If it is determined in operation S431 that the input data has not been received, the displaying unit 240 keeps the current image displayed in operation S433. In other words, the displaying unit 240 displays existing tag data provided from the tag driving unit 220 until the displaying unit 240 receives new tag data from the tag driving unit 220.

If it is determined in operation S431 that the input data has been received, the tag driving unit 220 updates the tag data using the input data and provides the updated tag data to the display driving unit 230 in operation S435.

In operation S437, the display driving unit 230 generates the image signal corresponding to the tag data and provides the image signal to the displaying unit 240, and the displaying unit 240 displays the image corresponding to the image signal. Thus, the displaying unit 240 displays the updated tag data.

As described above, the displaying unit 240 displays currently stored tag data until the currently stored tag data is updated. Thus, the user can recognize the current state of the RFID tag 200 without using the RFID reader 100. As a result, the RFID tag 200 can improve the convenience of the user.

As described above, according to the present invention, an RFID tag can include a displaying unit displaying tag data indicating a current state of the RFID tag. The displaying unit can display the tag data stored in the RFID tag even when the RFID tag does not exist within a read range of an RFID reader. Thus, a user can recognize the current state of the RFID tag without using the RFID reader. As a result, the RFID tag can improve convenience of the user. Also, although a power is cut off, the displaying unit keeps a current image displayed. The displaying unit consumes power only when the displaying unit displays a new image. Thus, the RFID tag can display the tag data using little power.

The foregoing exemplary embodiment and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An RFID (radio frequency identification) tag comprising:
a tag antenna which receives an input power and input data from an RFID reader and which transmits ID (identification) information corresponding to the input power to the RFID reader;
a tag driving unit which provides the ID information to the tag antenna and which updates and stores tag data which indicates a current state of the RFID tag using the input data; and
a displaying unit driven using the input power received through the tag driving unit and which displays an image corresponding to the tag data.

2. The RFID tag of claim 1, wherein the displaying unit keeps a current image displayed even when a power is cut off, and the displaying unit consumes power when new tag data is received to display a new image.

3. The RFID tag of claim 2, wherein the displaying unit is formed of an electronic paper.

4. The RFID tag of claim 1, further comprising a display driving unit which receives the input power and the tag data from the tag driving unit to generate an image signal and which provides the image signal to the displaying unit.

5. The RFID tag of claim 1, wherein the tag driving unit comprises:
a memory which stores the ID information and the tag data; and
a controller which detects the ID information from the memory, provides the ID information to the tag antenna, updates the tag data using the input data, and provides the input power and the tag data to the displaying unit.

6. A method of driving an RFID (radio frequency identification) tag, comprising:
receiving an input power from an RFID reader;
detecting ID information corresponding to the input power and transmitting the ID information to the RFID reader; and
receiving input data from the RFID reader to update and display tag data.

7. The method of claim 6, wherein the receiving of the input data from the RFID reader to update and display the tag data comprises:
determining whether the input data has been received;
if it is determined that the input data has not been received, keeping a current image displayed;
if it is determined that the input data has been received, updating the tag data using the input data; and
displaying the updated tag data.

8. The RFID tag of claim 1, wherein the displaying unit keeps a current image displayed even when a power is cut off, and the displaying unit consumes power only when new tag data is received to display a new image.

9. The RFID tag of claim 1, wherein the displaying unit comprises an upper electrode, a lower electrode and a plurality of micro capsules interposed between the upper and lower electrodes.

10. The RFID tag of claim 9, wherein the plurality of micro capsules comprise micro capsules with clear fluids, micro capsules with negatively electrified ink particles and microcapsules with positively electrified ink particles.

11. An RFID (radio frequency identification) tag comprising:
a tag antenna which receives input power and input data from an RFID reader; and
a display unit which displays tag data based on the input data received from the RFID reader;
wherein the displayed tag data remains the same until a new input data is received from the RFID reader.

12. The RFID tag of claim 11, wherein the RFID tag consumes power only during a period in which the new input data is received and the displayed tag data is updated.

13. The RFID tag of claim 11, wherein the RFID tag does not consume power during the period in which the displayed tag data remains the same.

14. The RFID tag of claim 11, wherein the display unit comprises electronic paper.
